(19) United States
(12) Patent Application Publication
(10) Pub. No.: US 2026/0350864 A1
(43) Pub. Date: Nov. 5, 2026

(54) AUTO-REGRESSIVE POLYLINES MODEL

(71) Applicant: Nearmap US, Inc., Lehi, UT (US)

(72) Inventors: Nagita Mehr SERESHT, Barangaroo NSW (AU); Peter RICKWOOD, Barangaroo NSW (AU); Fei MAI, Barangaroo NSW (AU)

(73) Assignee: Nearmap US, Inc., Lehi, UT (US)

(21) Appl. No.: 19/194,762

(22) Filed: Apr. 30, 2025

(51) Int. Cl. G06T 11/23; G06V 10/26; G06V 10/52; G06V 10/82; G06V 20/10

(52) U.S. Cl. CPC G06T 11/23; G06V 10/26; G06V 10/52; G06V 10/82; G06V 20/176

(57) ABSTRACT

A system and method for automatically analyzing digital images and creating outlines/polygons that are generated and overlaid on the digital image based upon automatically identified features in the digital image, the method including obtaining a source sequence by partitioning the image into a plurality of non-overlapping sections to generate image section representations and processing the image section representations via an encoder, semantic segmentation prediction data, and a decoder, and predicting a target token type and a vertex location from the decoder representations to generate a token sequence, which is used to generate a polygon.

### BACKGROUND

### 1. Field of the Invention

The present disclosure is related to a system for automatically drawing outlines/polygons on images. More particularly, the present disclosure is related to a system and method for automatically analyzing digital images and creating outlines/polygons that are generated and overlaid on the digital image based upon automatically identified features in the digital image.

### 2. Description of Related Art

Systems for analyzing a roof or a building condition have proliferated in recent years. The ability to take pictures of a property via aerial photography and later perform an analysis of the images to derive data on the condition of a roof or building provides significant advantages including limiting the need for an in-person visit and survey of a property.

Additionally, photographs of a property taken sequentially over a period of months/years, can help an insurance company see the change in the state of a property and allow the company to more accurately assess risk related to the property. These systems have adapted the use of neural networks to extract and analyze features from the input data. Such a system is disclosed in U.S. Patent Application No. 2025/0003745.

Still further, having accurate information about a roof for building can facilitate accurate estimates for repairs or replacement. Various systems have been presented to accomplish remote take-offs of roofs or various aspects of buildings. One of the ways such systems operate is to facilitate direct measurements on a roof. For example, a user utilizing a computer program can draw directly onto a 3D mesh (that has been generated by 2D images), which presents an overhead view of a roof to the user. The user can draw and outline corresponding to a roof section, which the system will then convert to an accurate area measurement of the section. This information can then be used to determine the materials necessary for the replacement of that section. However, while such systems are a big leap forward over previous methods, a problem with these systems is that they require direct user input (e.g., each section of roof must be user-drawn for estimation).

Accordingly, there is a need for an intelligent system and method that overcomes, alleviates, and/or mitigates one or more of the aforementioned and other deleterious effects of prior art property assessment systems.

### SUMMARY

Accordingly, what is desired is a system and method that automatically identifies features of a property derived from aerial images taken of the property.

It is also desired to provide a system and method that facilitates a computer model drawing lines or polygons on imagery based solely on imagery input into the system.

It is further desired to provide a system and method that utilizes artificial intelligence (AI) to predict sequences of coordinates (i.e., x, y positions in 2D space) as an output while facilitating arbitrary prompting of the model including class prompt tokens to indicate what semantic class is represented by an outline/polygon.

It is still further desired to provide a system and method that utilizes AI to predict sequences of coordinates as an output while providing class prompt tokens to indicate a class represented by the polygons and avoids the high computational cost of a single stage pixel-wise classification.

It is still further desired to provide a system and method that uses AI to predict sequences of coordinates as an output while providing class prompt tokens to indicate a class represented by an outline/polygon that decouples image processing from prompting/annotation.

The present system comprises a computer model that directly ‘draws’ lines or polygons on imagery. An analogy can be made with Large Language Models (LLMs), but instead of outputting words, the present system outputs lines and polygons (as annotations on an image). For example, an LLM will output a sequence of words/word-parts with an appropriate text prompt. The present system will output a sequence of (x, y) coordinates (with lines or polygons) with an appropriate image and token prompt.

The system differs from standard deep learning-based vision models in that it directly predicts sequences of coordinates (i.e., x, y positions in 2D space) as an output. In particular, the system provides for arbitrary prompting of the model (i.e., class prompt tokens to indicate what semantic class is represented by the outlines/polygons). For example, the model can be prompted to annotate roof panels, or building outlines, or solar panels, or any other object the model has been appropriately trained for.

Accordingly, a system is provided using an autoregressive vision transformer model that takes imagery, as well as a prompt and side ‘hints’, and can then produce high quality annotations (lines, polygons) on the image, at low computational cost relative to other models.

To achieve this, the system uses an efficient two-stage approach to predict coordinates by classification (rather than regression) to avoid paying the high computational cost of a single stage pixel-wise classification. The two-stage approach to predicting coordinates includes a ‘coarse’ stage where it picks the approximate location and then a ‘fine’ stage where it refines that location. The system facilitates additional prompting/hints to be provided to the model as side inputs to the decoder. This decouples image processing from prompting/annotation. For example, if semantic segmentation predictions are available for the object(s) of interest, they can be provided as a side ‘hint’ to the decoder, to assist in annotation.

A novel scheme is used that allows the system to cap the size of the context window of the decoder (at N tokens), without a reduction in accuracy. This is achieved as follows: a) a DONE mask is used that uses the side ‘hint’ mechanism discussed above to indicate the portions of the image already processed; and b) truncating the sequence (discarding uninformative tokens) and masking the sequence to only calculate loss for tokens with at least a specified minimum context.

The system functions on the principle that lines/linear rings are a sequence of vertices. These can be treated as a “next token” prediction (e.g., like LLMs). The computer model predicts the next geometric token, which is the next vertex (type and position).

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The term “network” as used herein includes both networks and internetworks of all kinds, including the Internet, and is not limited to any particular type of network or inter-network.

The terms “first” and “second” are used to distinguish one element, set, data, object or thing from another, and are not used to designate relative position or arrangement in time.

The terms “coupled”, “coupled to”, “coupled with”, “connected”, “connected to”, and “connected with” as used herein each mean a relationship between or among two or more devices, apparatus, files, programs, applications, media, components, networks, systems, subsystems, and/or means, constituting any one or more of (a) a connection, whether direct or through one or more other devices, apparatus, files, programs, applications, media, components, networks, systems, subsystems, or means, (b) a communications relationship, whether direct or through one or more other devices, apparatus, files, programs, applications, media, components, networks, systems, subsystems, or means, and/or (c) a functional relationship in which the operation of any one or more devices, apparatus, files, programs, applications, media, components, networks, systems, subsystems, or means depends, in whole or in part, on the operation of any one or more others thereof.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

As used herein, the term “transformer encoder” refers to a component of the transformer architecture that processes input sequences (like words in a sentence or image patches in an image) in parallel and creates contextualized representations of each element in the sequence. It weighs the importance of different elements in relation to each other by using self-attention mechanisms.

As used herein, the term “transformer decoder” refers to a component of the transformer architecture that generates output sequences based on both the encoded representation from the encoder and previously generated outputs. It contains self-attention layers (to focus on relevant parts of what it has already generated) and cross-attention layers (to focus on relevant parts of the encoder's output).

As used herein, the term “token sequence” means a series of coordinates and special tokens that are used to form a line or a polygon on an image.

In one configuration, a method for method for automatically generating geometric shapes with a computer program executing on a computer where the geometric shapes are automatically overlaid on an image is provided, the program performing the steps of receiving an image with the program executing on the computer, obtaining a source sequence by partitioning the image into a plurality of non-overlapping sections to generate image section representations, and processing the sequence of image section representations via a transformer encoder to generate encoder representations. The method further comprises the steps of processing the image to generate semantic segmentation prediction data and processing the encoder representations and semantic segmentation prediction data with a transformer decoder to generate decoder representations. The method still further comprises the steps of predicting a target token type and a vertex location from the decoder representations to generate a token sequence and processing the token sequence to generate a polygon.

In another configuration, a system for automatically generating geometric shapes where the geometric shapes are automatically overlaid on a digital image comprising: a computer having a computer program executing thereon, the computer adapted to receive a digital image. The system is provided such that the program obtains a source sequence by partitioning the image into a plurality of non-overlapping sections to generate image section representations, and the program has a transformer encoder processing the sequence of image section representations to generate encoder representations. The system is further provided such that the program processes the image to generate semantic segmentation prediction data, and the program has a transformer decoder processing the encoder representations and semantic segmentation prediction data to generate decoder representations. The system is still further provided such that the program predicts a target token type and a vertex location from the decoder representations to generate a token sequence, and the program processes the token sequence to generate a polygon.

The above-described and other features and advantages of the present disclosure will be appreciated and understood by those skilled in the art from the following detailed description, drawings, and appended claims.

### DESCRIPTION OF THE DRAWINGS

FIG. 1 is an illustration of an output of a computer model that, based on an image input automatically draws polygons for each roof panel/facet.

FIG. 2 is an illustration of an output of a computer model that, based on an image input automatically defined outlines/polygons for various features in the image.

FIG. 3 is a functional block diagram of a system for automatically providing polygons on images input into a computer model as according to the invention.

FIG. 4 is a functional block diagram showing the system process steps that are discussed in greater detail according to the system and method of FIG. 3.

FIG. 5 is a functional block diagram showing the system process steps that are discussed in greater detail according to the system and method of FIG. 3.

FIG. 6 is a functional block diagram showing the system process steps that are discussed in greater detail according to the system and method of FIG. 3.

FIG. 7 is a functional block diagram showing the system process steps that are discussed in greater detail according to the system and method of FIG. 3.

FIGS. 8A & 8B are illustrations of the output according to FIG. 7 of converting vectors to vertices sequence via classification.

FIGS. 9A & 9B are illustrations of next vertex prediction occurring by coarse-fine position classification with FIG. 8A showing next vertex position after refinement and FIG. 8B showing next vertex position coarse position likelihood according to the system and method of FIG. 3.

FIG. 10A-10C illustrate processing and output for the building outline according to the system and method of FIG. 3.

FIG. 11A-11C illustrate processing and output for the building outline according to the system and method of FIG. 3.

FIG. 12A-12C illustrate processing and output for the building outline according to the system and method of FIG. 3.

FIG. 13A-13D illustrate processing and output for Parcels according to the system and method of FIG. 3.

FIG. 14A-14D illustrate processing and output for Parcels according to the system and method of FIG. 3.

FIG. 15A-15B illustrate processing and output for Roof facets according to the system and method of FIG. 3.

FIG. 16 illustrates generation of LOD 2.2/2.3 roofs according to the system and method of FIG. 3.

FIG. 17 illustrates the generation of polygons identifying Building sections according to the system and method of FIG. 3.

FIG. 18 is a flow diagram of the model according to the system and method of FIG. 3.

FIG. 19 is a flow diagram according to FIG. 18.

FIG. 20 is a flow diagram according to FIG. 19.

FIG. 21 is a flow diagram according to FIG. 19.

### DETAILED DESCRIPTION

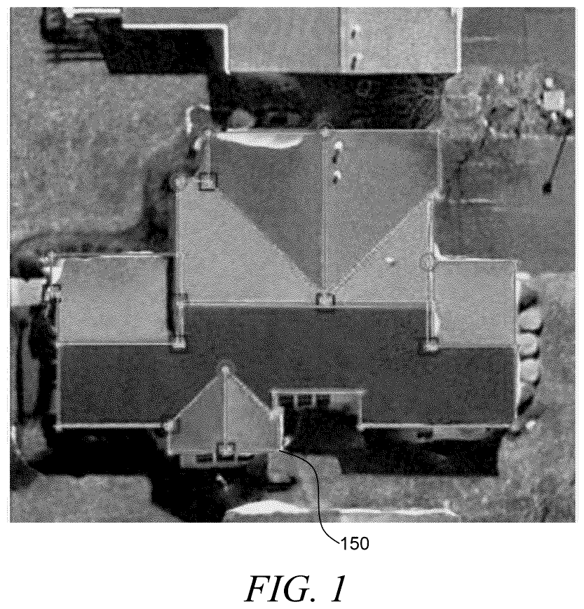

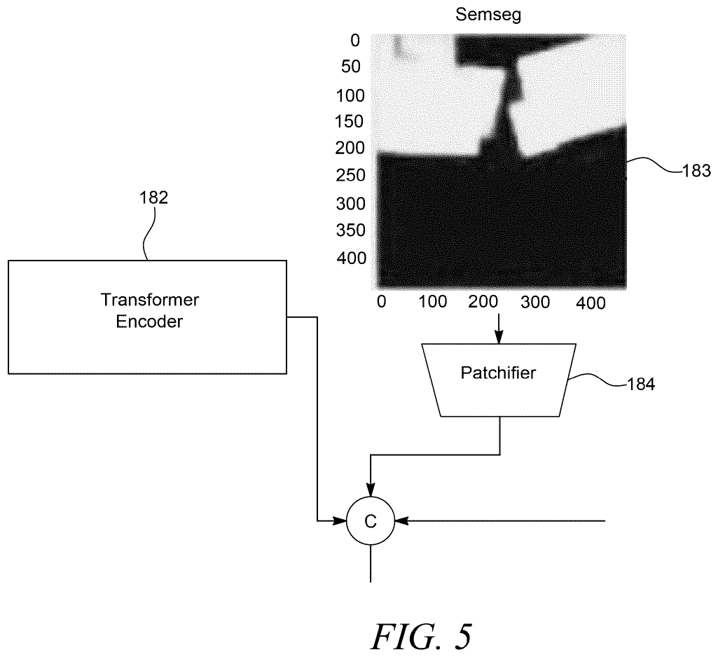

FIG. 1 is a sample output of a system 100 (FIG. 5), where the computer model has been given an input image comprising an overhead view of a building and automatically draws outlines/polygons 150 for each roof panel/facet.

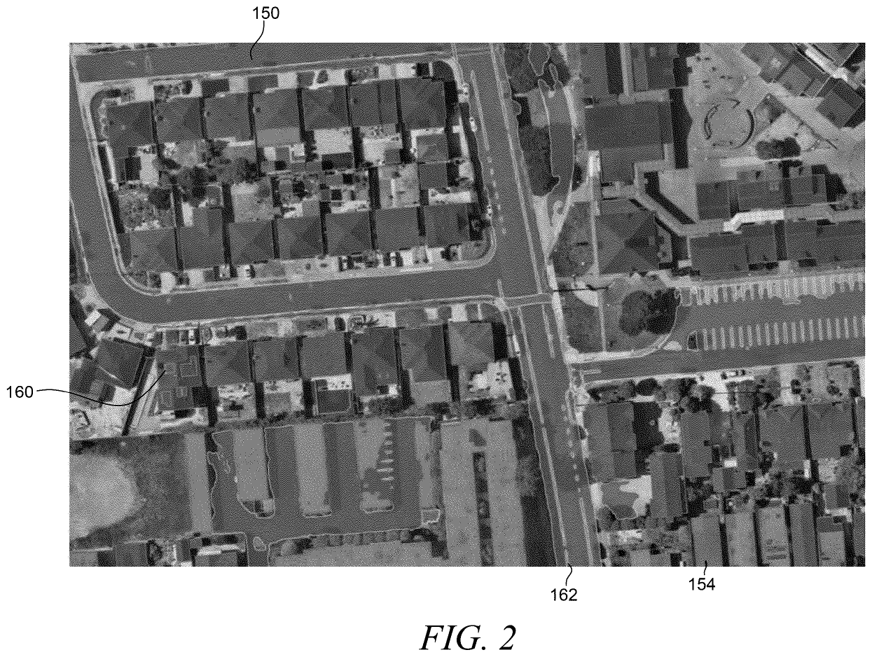

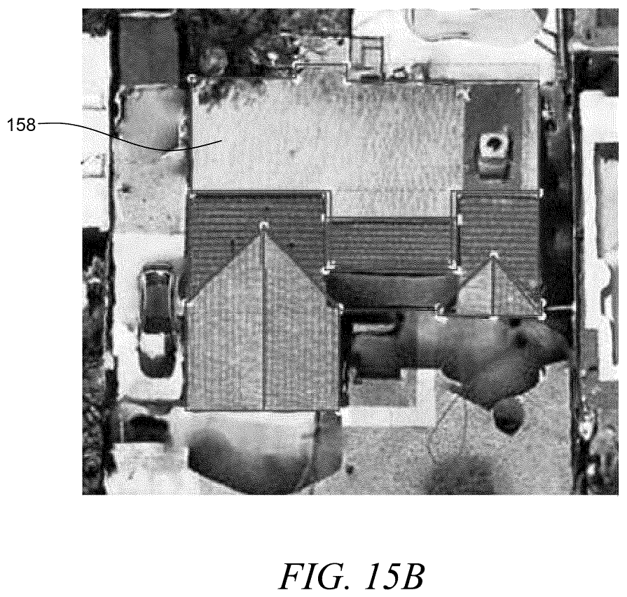

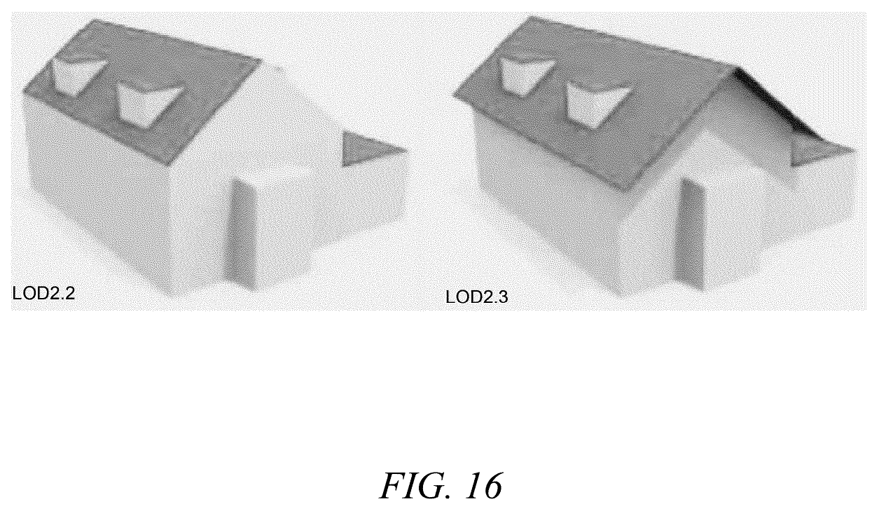

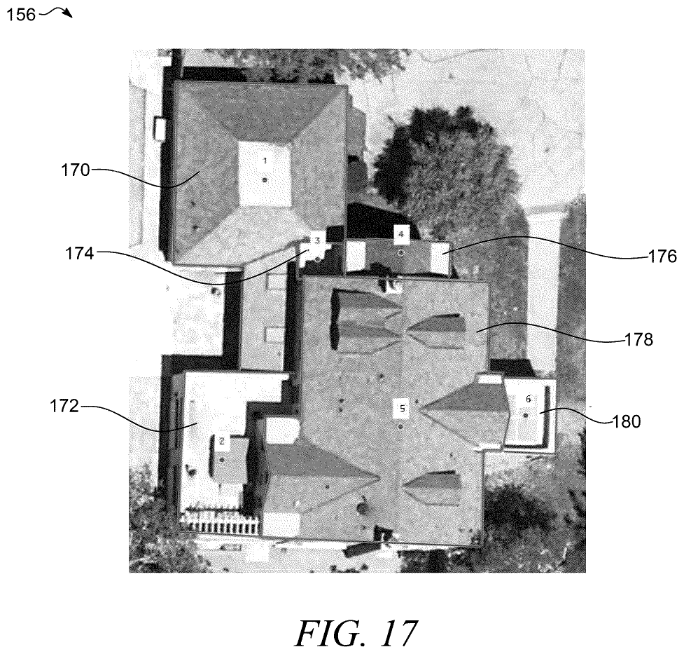

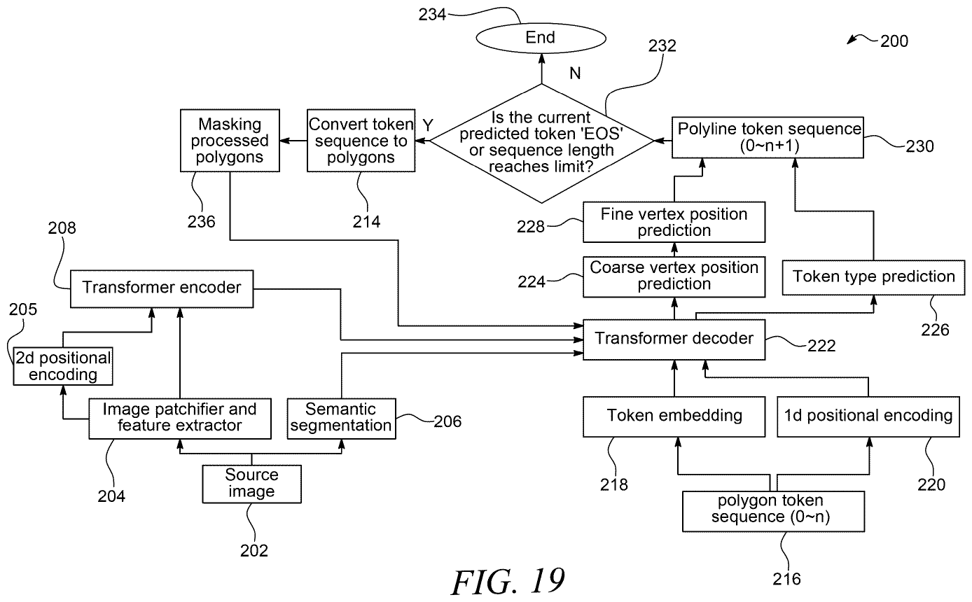

FIG. 2 illustrates a wide range of objects that can be automatically defined by outlines/polygons 150 including but not limited to: parcel/property boundaries 152 (FIGS. 15A-16D), building outlines 154, building sections/parts 156 (FIG. 19), roof panels/facets 158 (FIGS. 17A-17B), solar panel outlines 160, and linear objects 162 (e.g., power lines, road center lines, etc.).

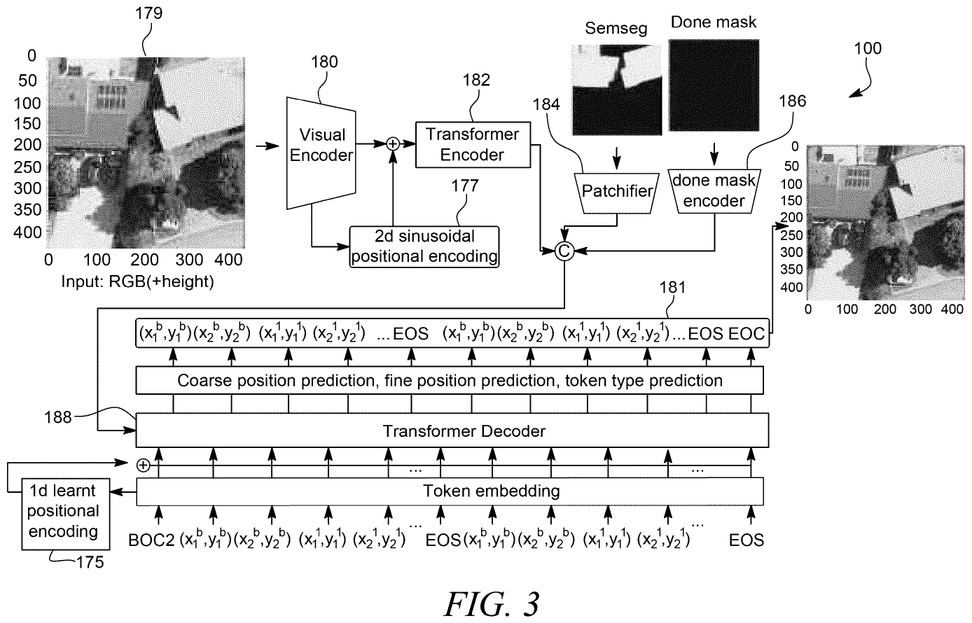

The functioning of the system 100/computer model will now be discussed in connection with FIG. 3, which shows an overall diagram of one configuration of the model. The system comprises a visual encoder 180, a transformer encoder 182, a patchifier 184, a done mask encoder 186, and a transformer decoder 188.
1) Initially, the model receives an image 179 and produces a token sequence 181 presenting polygons.

The term “token sequence” as previously defined, can be used to represent a series of polygons or lines. Essentially, a sequence of tokens represents lines ‘drawn’ on the image. Tokens are needed to represent ‘pen-down, move pen to location (x, y), pen up, and so on’. We do not have those tokens exactly, but something similar: a discrete sequence of elements (tokens) represent data (lines, polygons) in a structured format. In this context, it means a polygon is represented by a sequence such as [‘BOC 2’, (x0,y0), (x1,y1), . . . , (xn, yn), ‘EOS’, ‘EOC’], where the tokens are either special tokens like ‘BOC 2’ (indicating the beginning of sequence for class 2, such as a roof), ‘EOS’ (there are no more vertices in the current polygon/polyline being drawn), ‘EOC’ (there are no more objects left of the current class (roof in this case)), or vertex locations (xi, yi) in the object currently being drawn. In one configuration, the special tokens serve as delimiters that indicate where a sequence begins and ends.
2) The token sequence is a mixture of special tokens (BOC 2, EOS, EOC) and specific coordinate vertex locations.

The term “special token” referred to relates to delimiters that indicate where a sequence begins and ends. For example, with: [‘BOC 2’, (x00, y00), (x01, y01), . . . , (x0n, y0n), ‘EOS’, (x10, y10), (x11, y11), . . . , (x1n, y1n), ‘EOS’, ‘EOC’]. ‘BOC 2’ stands for ‘beginning of class 2’ (2 is the class id for a particular semantic class, roof, in this example). The proposed model can generate outline/polygons for different objects/semantic classes (such as roof, swimming pool and roof panels etc.).
“EOS” stands for the ‘end of sequence,’ which is the end for a single polygon. An image may have multiple objects and therefore the model generates multiple polygons, which is represented by one token sequence. The token sequence is delimited by “EOS” for different polygons. In the above example, there are two polygons in the image (x00, y00), (x01, y01), . . . , (x0n, y0n) and (x10,y10), (x11, y11), . . . , (x1n, y1n).
“EOC” stands for the ‘end of class,’ which indicate the end of the full token sequence (e.g., there are no more roofs left to describe/draw in the image).
3) The image is input into the visual encoder 180 to get image patch features extracted.

Image patch features are numerical representations of small image regions, capturing patterns like edges, colors, and textures. So, think of each small patch of the image being described, in one configuration, by a high-dimension vector of numbers, which may describe that patch of the image and its relation to the rest of the image.
4) The transformer is then used to generate the next tokens by looking at the image patch features and the previous token features. Auto-regressively, it produces a sequence of tokens.

The transformer processes information from two sources simultaneously to predict each token in the sequence: the visual information (image patch features) and the sequence context (previous token features).

So, in simple terms, suppose the model is halfway through ‘drawing’ the outline of a roof. To decide where to place/draw the next part of the roof outline, it needs to refer to previous tokens (i.e., what it has drawn already), and what is in the image (the image patch features), to correctly recognize that it needs to place the next vertex at (say) the corner of the building.

More technically: when generating each new token, the transformer uses self-attention mechanisms to analyze relationships between all previously generated tokens, understanding the partial polygon constructed so far. Meanwhile, it uses cross-attention to connect this sequence information with the relevant visual features from the image patches. This dual attention allows the model to maintain geometric consistency by referencing the actual image content while following the logical structure of a polygon definition. Each new token is predicted based on both what the model “sees” in the image and what it has already “described” in the previous tokens.

Auto-regressive generation means the model produces tokens one at a time in sequence, with each new token dependent on all previously generated tokens. In this polygon extraction context, the process works like creating polygons step-by-step: at first, a ‘BOC 2’ is given to the model as the start token. The model uses visual information (image patch features) and the current token sequence (‘BOC 2’) and predicts the first vertex location in the first polygon (x00, y00) as the second token, and therefore the output token sequence is updated as (‘BOC 2’, (x00, y00)). This pattern continues for all vertices in all polygons until producing an EOC token. For example, when identifying a triangle and a quadrilateral in an image, the model might generate: [‘BOC 2’, (x00, y00), (x01, y01), (x02, y02), ‘EOS’, (x10, y10), (x11, y11), (x12, y12), (x13, y13), ‘EOS’, ‘EOC’]. The whole sequence takes ten predictions to finish, each of which builds upon the growing context of the polygon being described.
5) Finally, some side hints may be provided (e.g., semantic segmentation prediction) to the model.

The term “semantic segmentation prediction” here refers to a pixel-by-pixel map where every pixel is assigned a specific (semantic) class label with a likelihood value.

Depending on the application, the input data for the model varies. For example, it may include: 1) RGB only for Enhanced Building Outline version 4 (EBOv4) (i.e., vector representation of building outline) and parcel boundary; and 2) RGB+height (DSM-DTM) for roof panels and 2.5D. Digital Surface Model (DSM) and Digital Terrain Model (DTM), where “DSM-DTM”, subtracting the DTM from DSM gives the height map (relative to ground). “DTM” is also sometimes referred to as “DEM” Digital Elevation Model”. This is a bare earth model, with buildings, structures, trees removed.

“DSM” is height model containing all buildings, trees, etc.

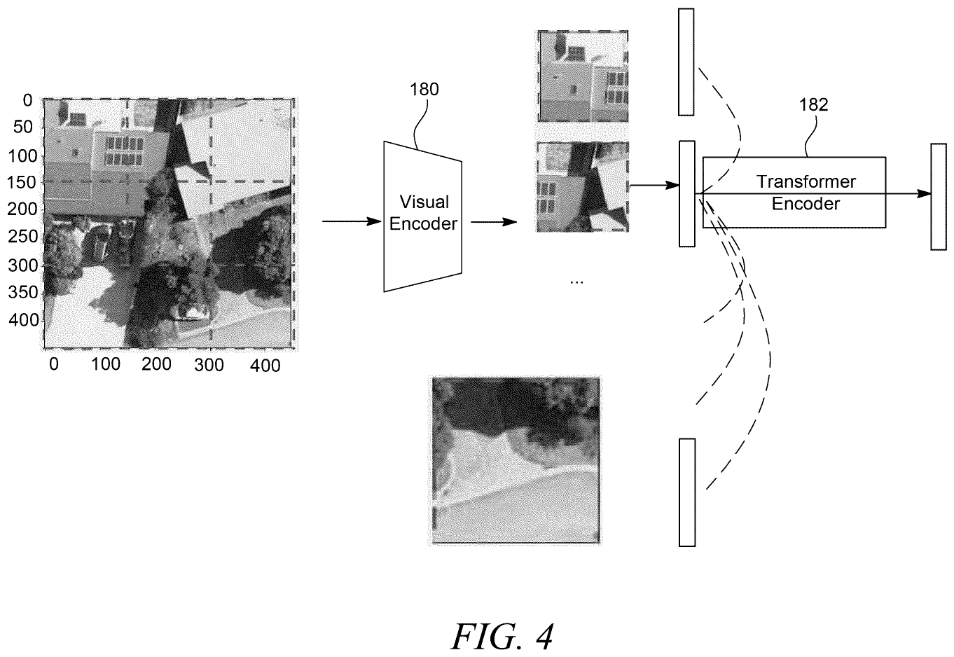

Referring now to FIG. 4, for image context-aware features: 1) the image is input into the visual encoder 180 to extract local patch level features; and 2) the local features go into the transformer encoder 182 to get context-aware features for the patches.

Referring to FIG. 5-8, the transformer decoder 188 provides a feature vector for each patch generated from the transformer encoder 182, where additional hints may be provided. For example, when determining a roof outline, a semantic segmentation raster 183 is helpful for the model to learn as shown in FIG. 5.

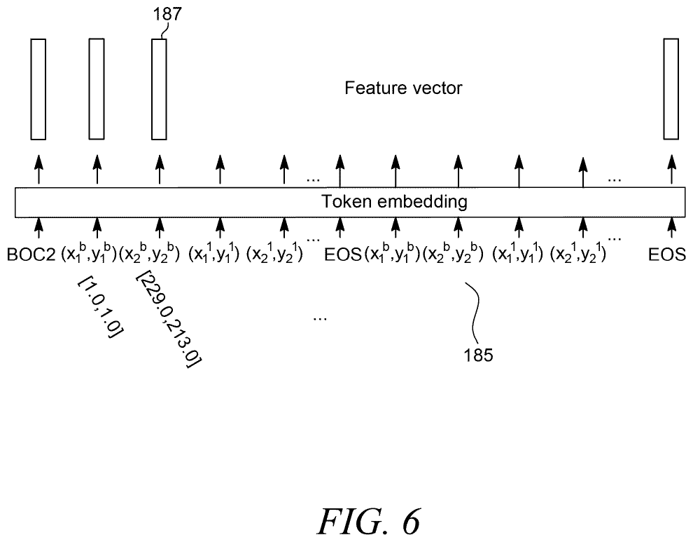

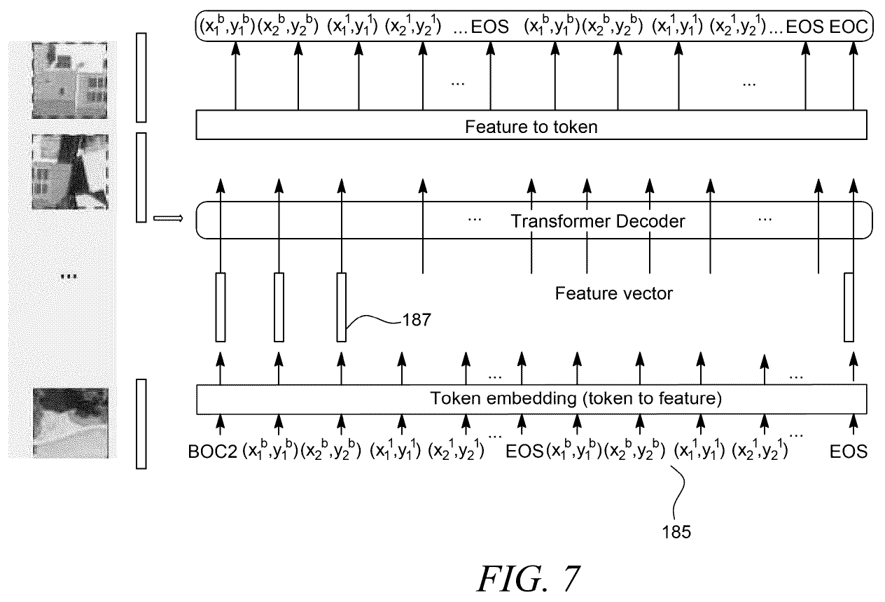

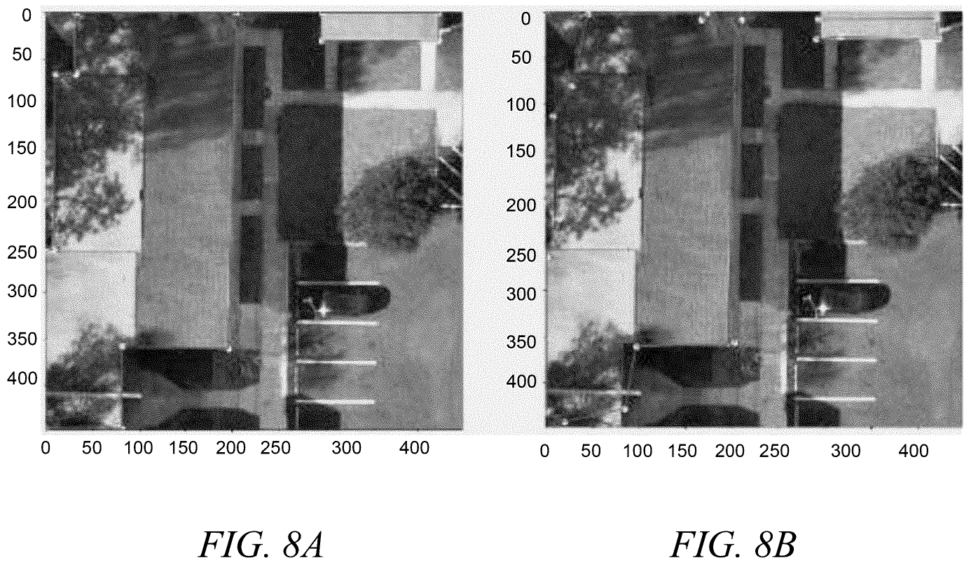

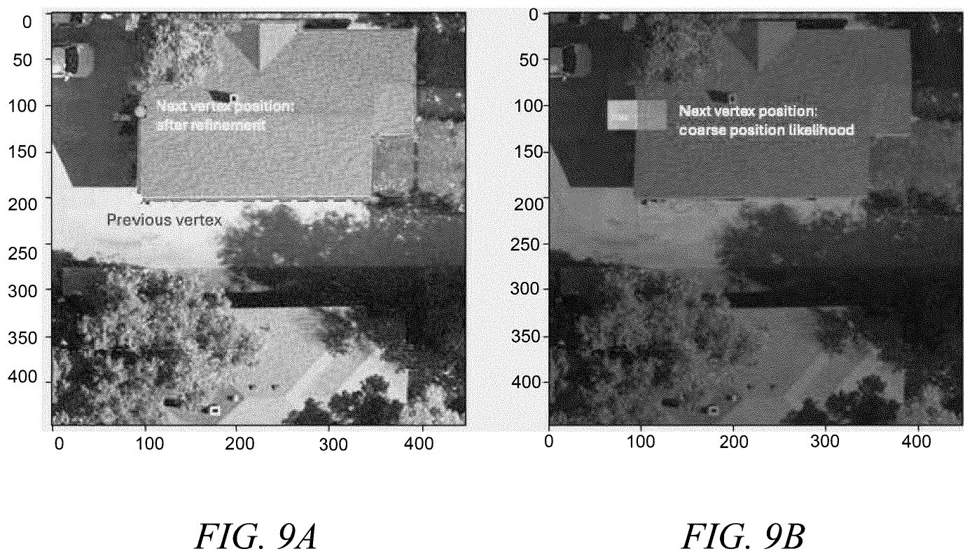

In FIG. 6 the system 100 facilitates converting tokens 185 to feature vectors 187. In FIG. 7 the system facilitates converting vectors 187 to token/vertices sequences 181. This occurs via classification as illustrated in FIGS. 8A & 8B, where a next vertex prediction may occur by coarse-fine position classification (FIGS. 9A & 9B).

Positional encoding includes, for an image before the transformer encoder 182, static 2d sinusoidal positional encoding 177 (FIG. 3), and for a polygon sequence before the transformer decoder 188, learned 1d embedding 175 (FIG. 3). Positional encoding is crucial in the transformer model because it explicitly provides information about the order of tokens within the sequence, allowing the model to understand the context of each token based on its position within the sequence.

Additionally, hints/prompts may be added before the transformer decoder 188, which may include BOC class_id—strong prompt. The system 100 can be prompted with different BOC class_id tokens, such that it will generate outlines/polygons 150 for different (multiple) classes. For example, a roof may be prompted with BOC roof_id to get roof outlines, or solar panels may be prompted with BOC solar_panel_id to get solar panels outlines.

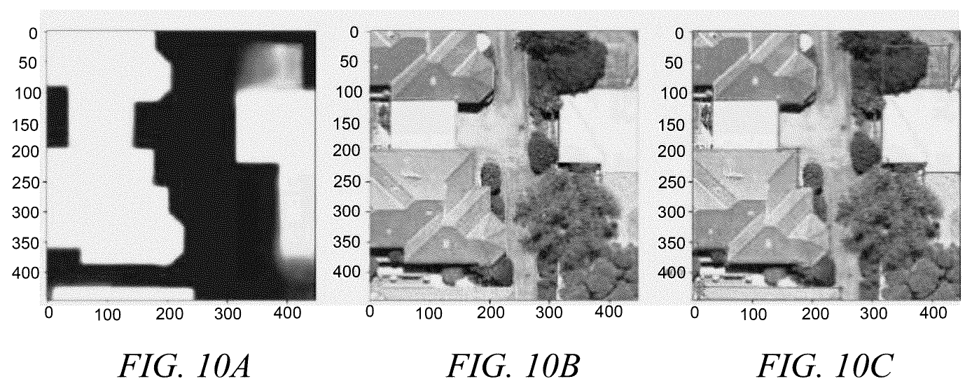

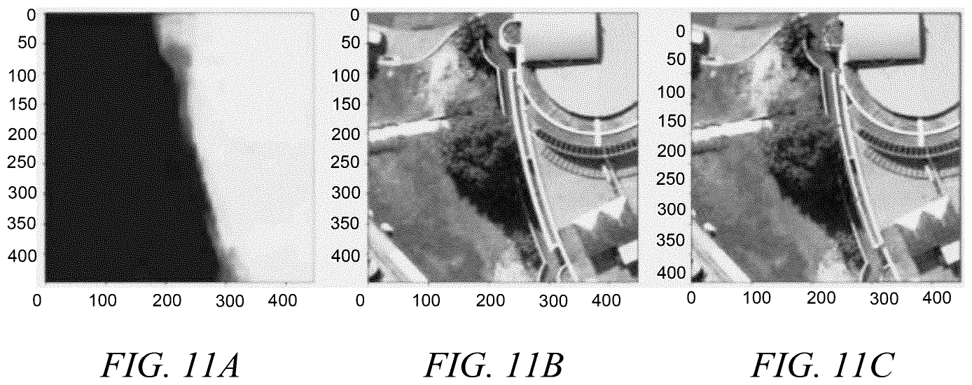

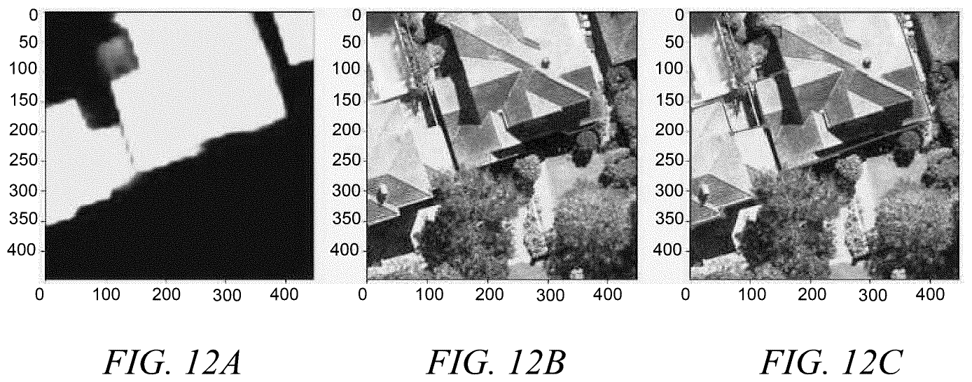

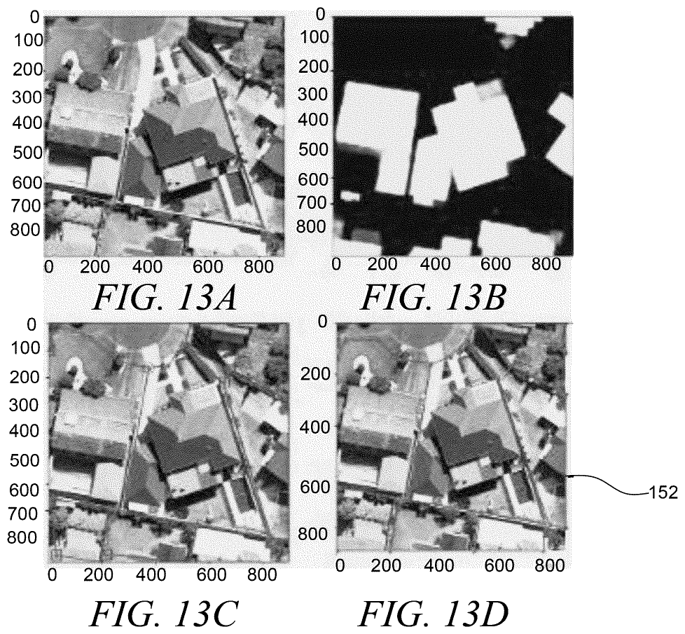

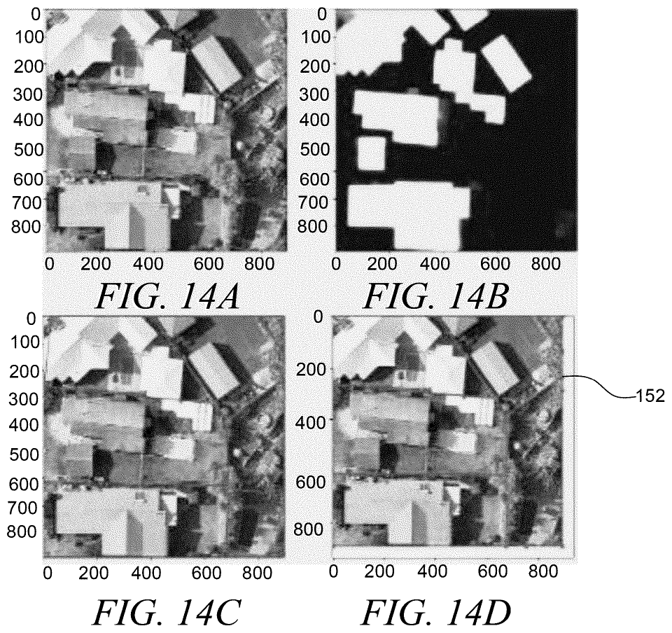

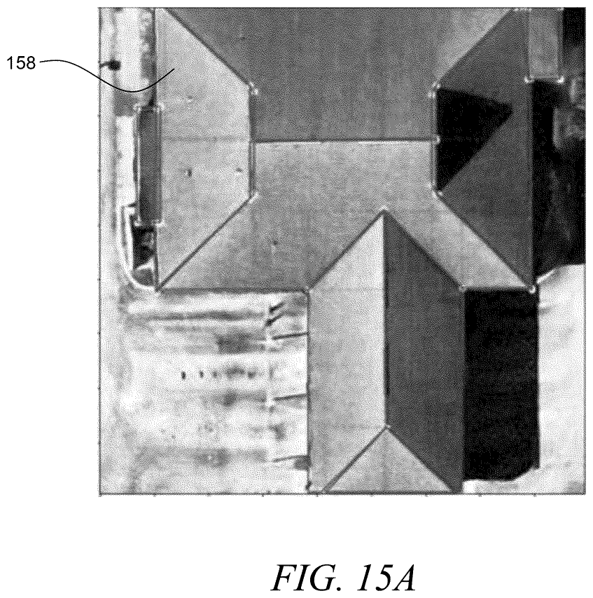

Those of skill in the art will understand there are many differing application areas for the system/computer model 100 including: building outlines (input: RGB) as shown in FIG. 10A-10C, 11A-11C, and 12A-12C; Parcels (input: RGB) as shown in FIG. 13A-13D and 14A-14D; Roof facets (Input: RGB+height) as shown in FIG. 15A-15B; LOD 2.2 Buildings (FIG. 16), where it is possible to apply the same model to generate Level of Detail (LOD) 2.2/2.3 roofs with the connected roof panels the model produces where LOD refers to the complexity of a 3D model representation and indicates how much information is included about an object depending on how close the viewer is to it (i.e., less detail is shown when viewed from a distance to optimize performance); Building sections as shown in FIG. 17 where the various building sections (170, 172, 174, 176, 178, 180) are labeled 1-6.

It is contemplated that the model could be used to compute features such as, facet counts, roof complexity, edge types (rake, eaves, etc.) and roof section types (gable, hip, etc.), and roof geometry triage.

Likewise, better 3D processing of roofs could be achieved with the model to detect points, lines, and/or planes in roofs (on the source imagery). These could be used for better 3D reconstruction of roofs, which are (almost always) planar. There are multiple possible methods for implementation including:
1) 2D (or approximate 3D prediction) Model runs on existing image or mosaic, including true ortho, photomosaics, vertical orthomosaic, or single source photo. This provides a roof topology to guide traditional photogrammetry. For example, the model decides, ‘there is a vertex near this location’, and traditional multi-view stereo can be used to locate and triangulate the vertex in 3D space from features in all overlapping source images.
2) 2D Model runs on multiple source images, generating multiple roof facet outlines. Triangulation of line segments is performed to determine the best fit for multiple candidate lines in 3D space.
3) Traditional multi-view stereo is used to extract initial 3D mesh. The model is run on the resulting 3D mesh, to extract roof topology. Roof facet polygons are then used to refine the 3D mesh (e.g., enforcing planar surfaces to create flat facets, enforcing linear edges to ensure mesh triangle edges are aligned to predicted roof edges).
4) 3D topology is embedded in the mesh format (e.g., to describe the polygon objects as a collection of triangles). This combines 3D mesh and 3D polygons in a single syntax, enabling the results of the models to be utilized for derived products including visualization and roof geometry.

From a functional standpoint, the foundation model should provide better image ‘feature patches’ and free/amortized image feature cost (one encoder, many decoders).

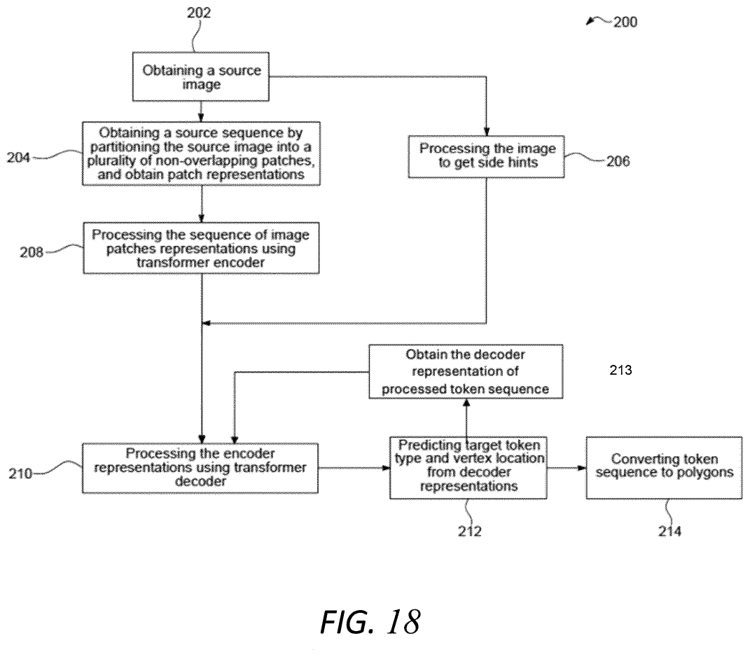

Referring now to FIG. 18-21, various flow diagrams for a process 200 are depicted.

FIG. 18 starts with obtaining a source image 202. The method then comprises obtaining a source sequence by partitioning the source image into a plurality of non-overlapping patches and obtaining patch representations 204. Simultaneously, the method could include processing the image to get side hints 206. In another configuration, from a functional standpoint, a foundation model could alternatively be used and would provide good image ‘feature patches’ and free/amortized image feature cost (one encoder, many decoders).

In FIG. 18 the method further includes processing the sequence of image patches representations using a transformer encoder 208. This output, the side hints and the decoder representation of the processed token sequence are then used to process the encoder representations using a transformer decoder 210. Next, the model predicts a target token type and vertex location from the decoder representations 212. From this, the system can obtain the decoder representation of processed token sequence 213. Finally, the token sequences are converted to polygons 214.

FIG. 19 provides an enhanced view of method 200 providing additional steps that are not depicted in FIG. 18. The steps previously described in connection with FIG. 18 will not be redescribed, however, an additional step is inserted in parallel from the image patchifier and feature extractor 204 step where an output thereof is used to perform 2d positional encoding 205, which is then fed into the transformer encoder 208 step.

Referring to FIG. 22, through the transformer encoder, the entire input sequence is processed through a plurality of encoder blocks arranged sequentially, wherein the output of each block serves as input to the subsequent block, thereby enabling hierarchical feature extraction and refinement.

The encoder block (step 208) is configured to receive a respective input embedding vectors (patch representations in this context) (step 204), which is additively combined with sequence positions (positional encoding) (step 205), making the position-aware embeddings. The position-aware embeddings are then processed through a multi-head attention layer 302 (FIG. 22), which are plurality of attention heads operating in parallel, where each attention head performs an attention mechanism over the whole sequence. The output from the plurality of attention heads are concatenated along the embedding dimension and projected through a linear transformation to produce a unified representation.

In some implementations, each encoder block also includes a residual connection layer that combines the outputs of the encoder self-attention sub-layer with the inputs to the encoder self-attention sub-layer to generate an encoder self-attention residual output and a layer normalization layer that applies layer normalization to the encoder self-attention residual output. These two layers are collectively referred to as an “Add & Norm” operation 304 in FIG. 22. The normalized output is then processed through a position-wise feed-forward network 306. A second residual connection is implemented wherein the input to the feed-forward network is additively combined with its output, followed by application of layer normalization 308.

Referring to FIG. 19, the steps of processing the encoder representations using a transformer decoder 210 and predicting a target token type and vertex location from the decoder representations 212 from FIG. 18 are expanded on in FIG. 19.

Additional steps described in connection with FIG. 19, including providing polygon token sequence (0~n) 216, which means the processed sequence consisting of tokens from the 0-th to the n-th. The polygon token sequence is used to perform token embedding 218, and 1d positional encoding 220. The outputs from those steps are both provided to a transformer decoder 222 step, which further receives the output from the transformer encoder 208 step and semantic segmentation 206.

Referring now to FIG. 23, the transformer decoder includes a plurality of decoder blocks where the output of each block serves as input to the subsequent block. Given a generation time step, a decoder block receives an encoder output sequence and a position-aware partially generated target embedding, which is the additive combination of partially generated output sequence embeddings 218 and their positional embedding 220. Then the position-aware partially generated target embeddings enter a masked self-attention mechanism to analyze relationships within the partially generated output sequence (step 310). In some implementations, each of decoder block also includes a residual connection layer that combines the outputs of the decoder self-attention sub-layer with the inputs to the decoder self-attention sub-layer to generate a decoder self-attention residual output and a layer normalization layer that applies layer normalization to the decoder self-attention residual output. These two layers are collectively referred to as an “Add & Norm” operation (step 312). The normalized decoder self-attention residual output, together with the encoder output embeddings, then enter a cross-attention mechanism to evaluate relationships between the input sequence and the partially generated output sequence (step 314). In some implementations, the decoder cross-attention output embeddings go through an “Add & Norm” operation (step 316) and get the normalized decoder output embedding.

Referring to FIG. 19, from the transformer decoder 222 step the output thereof is input into the step of coarse vertex position prediction 224 and to token type prediction 226. The output from the coarse vertex position prediction 224 step is input to the step of fine vertex position prediction 228. The output from the fine vertex position prediction 228 and the token type prediction 226 are both used to generate polyline token sequence (0~n+1) 230.

At this point, the model must decide: is the current predicted token End of Sequence (EOS) or has sequence length reached its limit 232. If ‘no’, the system ends 234 the current process to move onto the next prediction point. If ‘yes’, the process is complete, and the system proceeds to the step of converting the token sequences to a polygon 214. The output from the step of converting token sequences to a polygon 214 is used for the step of masking processed polygons 236, which may further be used as an input to the transformer decoder 222 step.

Referring to FIG. 24, the masking process is performed to generate a ‘done mask’ to indicate which polygons have been processed. The ‘done mask’ starts with an empty mask 318 until the first polygons are predicted. Then the ‘done mask’ is updated with the first predicted polygon areas 320 being masked as ‘done.’ The process continues by adding new ‘done’ areas to the done mask where polygons have been processed until all polygons 322 have been processed.

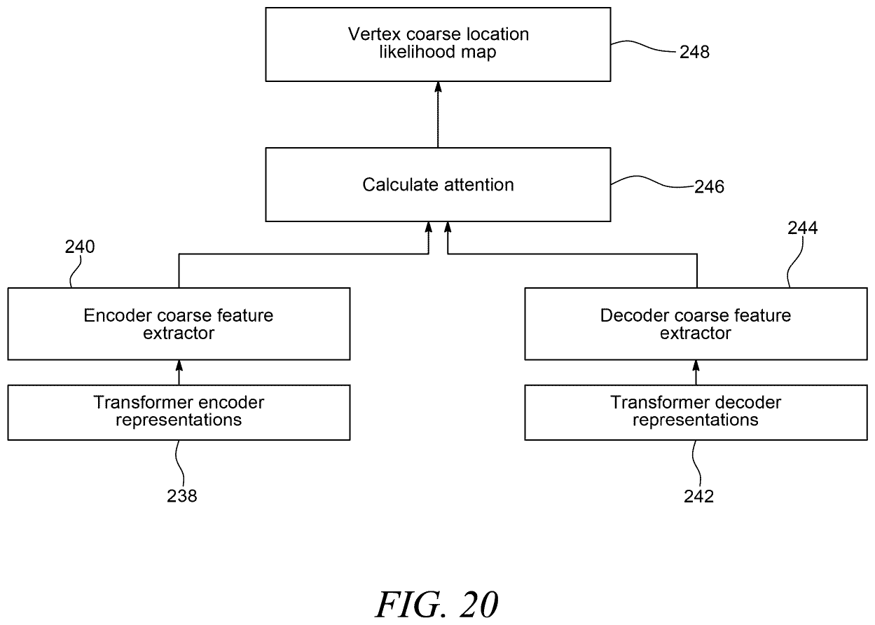

Turning now to FIG. 20, additional steps are shown to the processes depicted in FIG. 19. In FIG. 20, transformer encoder representations 238 are input to encoder coarse feature extractor 240. Additionally, transformer decoder representations 242 are input to decoder coarse feature extractor 244. The encoder coarse feature extractor is used to transform the raw encoder output and the decoder coarse feature extractor is used to transform the raw decoder output into a set of representative features both of which capture the coarse level of characteristics of the encoder/decoder output features. It may be implemented using, but not limited to, convolutional neural network layers or other machine learning algorithms suitable for identifying and extracting relevant features form the input data. One example of implementation of a encoder/decoder coarse feature extractor is a linear projection.

The outputs from the encoder coarse feature extractor 240 step and decoder coarse feature extractor 244 step are then used to calculate attention 246. Attention is a mechanism in neural networks that allows the model to focus on specific parts of the input that are relevant to what it's currently processing or querying. One example of implementations is to calculate the similarity score between the fine features, which represent the image and decoder fine features, which represent the coordinate tokens in the polygon token sequence. The calculation of attention 258 is used to generate a vertex coarse location likelihood map 248, which in turn is used in the step of coarse vertex position prediction 224 in FIG. 19. The vertex coarse location likelihood map is saved in the computer memory and used in the fine vertex position prediction step 228.

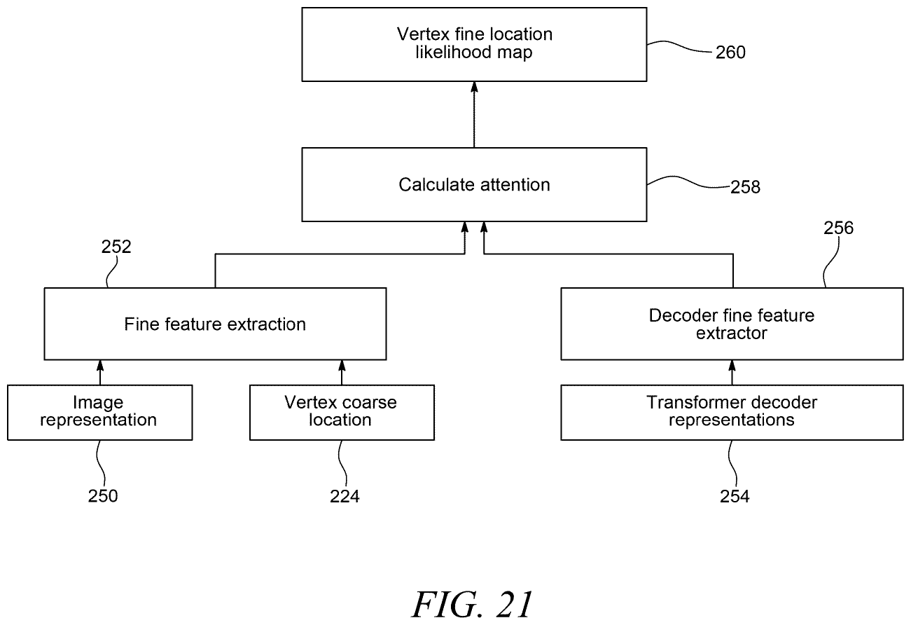

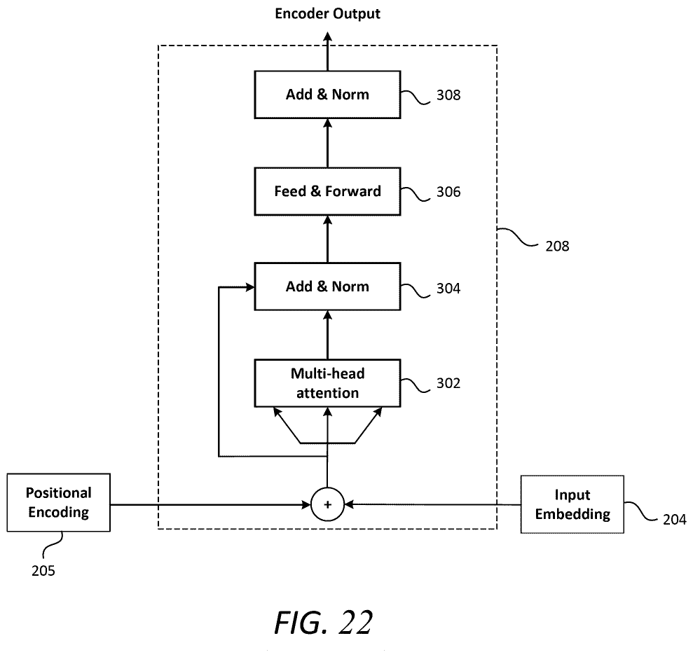

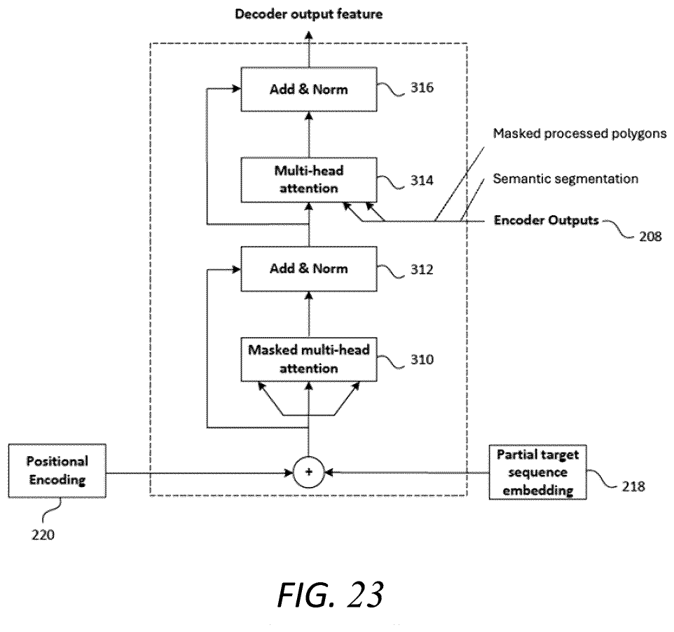

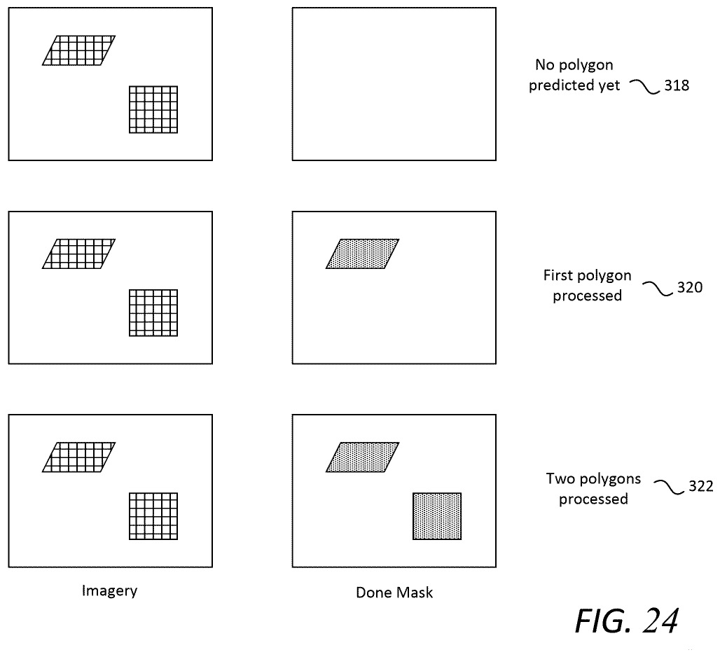

Referring now to FIG. 21, additional steps are shown to the processes depicted in FIG. 19. In FIG. 21, an image representation 250 and the output from the step of coarse vertex position prediction 224 are used for the step of fine feature extraction 252. The fine feature extraction model receives image features 250 (which is the output of image patchifier 184 and feature extractor 204), and the vector coarse location 224. One source of the coarse location is the label of the vertex in the training phase. Another example of the coarse location is the location of the maximum value in the coarse location likelihood map 248. The fine feature extractor then extracts the image features at the coarse locations.

Transformer decoder representations 254 are input to the step of decoder fine feature extraction 256. The decoder fine feature extractor is provided to transform the raw decoder output to a set of representative features therefrom, which captures the fine level of characteristics of the decoder output features. It may be implemented using, but not limited to, convolutional neural network layers or other machine learning algorithms suitable for identifying and extracting relevant features from the input data. As discussed in connection with the decoder coarse feature extractor, an example of implementation of the decoder fine feature extractor is a linear projection.

The outputs from the fine feature extraction 252 and decoder fine feature extraction 256 are both used to calculate attention 258. As previously stated, attention is a mechanism in neural networks that allows the model to focus on specific parts of the input that are relevant to what it's currently processing or querying. The calculation of attention 258 is then used to generate a vertex fine location likelihood map 260, which in turn is used in the step of fine vertex position prediction 228 in FIG. 198. The vertex fine location likelihood map is saved in computer memory and used in determining the location of the vertex in the image (i.e., the final vertex token in the polygon sequence 230).

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A method for automatically generating geometric shapes with a computer program executing on a computer where the geometric shapes are automatically overlaid on an image, the program performing the steps of:
receiving an image with the program executing on the computer;
obtaining a source sequence by partitioning the image into a plurality of non-overlapping sections to generate image section representations;
processing the sequence of image section representations via an encoder, or a CNN, or an encoder plus a CNN, to generate encoder representations;
processing the image to generate prediction data;
processing the encoder representations and prediction data with a transformer decoder to generate decoder representations;
predicting a target token type and a vertex location from the decoder representations to generate a token sequence; and
processing the token sequence to generate a polygon.

2. The method of claim 1, further comprising the step of:
2d positional encoding is performed on the sequence of image section representations, which is input to the transformer encoder and used to generate the encoder representations.

3. The method of claim 2, further comprising the steps of:
performing coarse vertex position analysis on the decoder representations to generate coarse vertex position predictions; and
performing token type analysis on the decoder representations to generate token type predictions.

4. The method of claim 3, further comprising the steps of:
performing fine vertex position analysis on the coarse vertex position predictions to generate fine vertex position predictions; and
generating a polyline token sequence with the fine vertex position predictions and the token type predictions.

5. The method of claim 4, wherein when the polyline token sequence reaches a limit or a current predicted token is indicated as End of Series (EoS), the polyline token sequence is used to generate to generate the polygon.

6. The method of claim 5, wherein the generated polygon is masked and is used as an input to the transformer encoder for future processes.

7. The method of claim 5, further comprising the steps of:
the encoder representations are input into an encoder feature extractor that extracts encoder coarse features;
the decoder representations are input into a decoder feature extractor that extracts decoder coarse features;
using the encoder coarse features and the decoder coarse features to calculate attention to generate a vertex coarse location likelihood map; and
using the vertex coarse location likelihood map to generate the coarse vertex position predictions.

8. The method of claim 6, further comprising the steps of:
using the image and the coarse vertex position predictions to perform fine feature extraction;
using the decoder representations to perform decoder fine feature extraction;
using the fine feature extractions and the decoder fine feature extractions to calculate attention to generate a vertex fine location likelihood map; and
using the vertex fine location likelihood map to generate the fine vertex position predictions.

9. The method of claim 1, wherein the image comprises real property, and the polygon is used to determine a portion of the real property selected from the group consisting of: a property parcel, a roof or roof facet, a building, a building section, a roadway, and combinations thereof.

10. The method of claim 1, wherein the encoder comprises a transformer encoder.

11. The method of claim 1, wherein the prediction data comprises semantic segmentation prediction data.

12. A system for automatically generating geometric shapes where the geometric shapes are automatically overlaid on a digital image comprising:
a computer having a computer program executing thereon, the computer adapted to receive a digital image;
the program obtaining a source sequence by partitioning the image into a plurality of non-overlapping sections to generate image section representations;
the program having a transformer encoder processing the sequence of image section representations to generate encoder representations;
the program processing the image to generate semantic segmentation prediction data;
the program having a transformer decoder processing the encoder representations and semantic segmentation prediction data to generate decoder representations;
the program predicting a target token type and a vertex location from the decoder representations to generate a token sequence; and
the program processing the token sequence to generate a polygon.

13. The system of claim 12, wherein the program performs 2d positional encoding on the sequence of image section representations, which is input to the transformer encoder and used to generate the encoder representations.

14. The system of claim 13, wherein,
the program performs coarse vertex position analysis on the decoder representations to generate coarse vertex position predictions; and
the program performs token type analysis on the decoder representations to generate token type predictions.

15. The system of claim 14, wherein,
the program performs fine vertex position analysis on the coarse vertex position predictions to generate fine vertex position predictions; and
the program generates a polyline token sequence with the fine vertex position predictions and the token type predictions.

16. The system of claim 15, wherein,
the program having an encoder feature extractor and the encoder representations are input into the encoder feature extractor that extracts encoder coarse features;
the program having an decoder feature extractor and the decoder representations are input into a decoder feature extractor that extracts decoder coarse features;
the program using the encoder coarse features and the decoder coarse features to calculate attention to generate a vertex coarse location likelihood map; and
the program using the vertex coarse location likelihood map to generate the coarse vertex position predictions.

17. The system of claim 16, wherein,
the program using the digital image and the coarse vertex position predictions to perform fine feature extraction;
the program using the decoder representations to perform decoder fine feature extraction;
the program using the fine feature extractions and the decoder fine feature extractions to calculate attention to generate a vertex fine location likelihood map; and
the program using the vertex fine location likelihood map to generate the fine vertex position predictions.
